(19) United States
(12) Patent Application Publication
(10) Pub. No.: US 2001/0045895 A1
(43) Pub. Date: Nov. 29, 2001

(54) Safety-off-switch for residential electric blower motor

(76) Inventors: Bruce C. Ellis, West Melbourne, FL (US); Ned Kesin, West Melbourne, FL (US); Glenn Summers, Melbourne, FL (US); Darren L. Cole, West Melbourne, FL (US)

Correspondence Address: Bruce C. Ellis, 40 Nina Jean Drive, West Melbourne, FL, 32904, US

(21) Appl. No.: 09/778,646

(22) Filed: Feb. 7, 2001

Related U.S. Application Data
(60) Provisional application No. 60/182,462, filed on Feb. 15, 2000.

(51) Int. Cl. G08B 17/10

(52) U.S. Cl. 340/632

(57) ABSTRACT

safety-off-switch interconnecting via electrical wire between residential smoke detectors and a residential air moving blower motor. Smoke or toxic gas detection unit upon sensing, transmits a signal indicative of an alarm condition to safety-off-switch. Safety-off-switch upon receiving alarm condition signal will disconnect electrical power to blower motor of residential air moving unit. When safety-off-switch no longer receives an alarm condition signal, blower motor will again be allowed to run.

### BACKGROUND

1. Field of Invention

Safety-Off-Switch relates to residential air blower motors and residential smoke detectors permanently connected to conventional main electrical power lines, specifically to a switch for disabling a residential blower motor in the presence of a toxic gas.

2. Discussion of Prior Art

A fire can smolder and produce smoke long before flame breaks out. Should occupants of a residence be sleeping, smoke might cause them to become unconscious and ensuing fire consume them. As is well known, that event has occurred in alarming numbers.

With invention and manufacture of smoke detectors, an early warning system was created. In event of a fire, occupants could then escape to safety.

Early smoke detectors, for the most part, were battery powered to facilitate being installed within an existing structure. So successful were smoke detectors at saving lives, due to early warning provided, many residential building codes now require smoke detectors be installed within all newly constructed residential dwellings. Additionally, as battery powered detectors did not provide a long life power source and some owners might not replace expended batteries, Residential building codes require smoke detectors be permanently connected to conventional main electrical power lines, contain a battery back-up and be connected via an electrical transmission line or cable known as an I/O data line, so that when one alarm sounds, all connected alarms will sound. This is commonly referred to as “daisy chained”.

However, no consideration has been given to the role of residential air handler in spreading smoke, and therefore not recognized as a problem by any prior art. Smoke when forced through air duct system by blower motor, can cause extensive damage to areas connected to that system and/or actually cause death to occupants. Insurance records show that, generally, more financial damage is caused by smoke than actual fire.

Various methods and systems for controlling conditions associated with a fire, such as smoke and temperature detection systems, are known, for example U.S. Pat. No. 4,637,473 describes a fire suppression system for a housing that receives and filters particulate matter. Upon detection of a predetermined temperature difference between the inlet and outlet, a control circuit closes a damper and deactivates a blower motor drawing air through the housing. U.S. Pat. No. 4,363,031 discloses a smoke detection system having a wireless transmitter that sounds a local alarm and transmits signals to other smoke detectors that, in turn, re-transmit the signal and sound local alarms. U.S. Pat. No. 4,659,909 discloses a smoke detector mounted adjacent to an electric kitchen range for detecting smoke and interrupting electrical power to the range.

Similarly, U.S. Pat. No. 3,926,101 describes a smoke detector system for a building that automatically locks certain doors and reverses the direction of fans. U.S. Pat. No. 4,063,595 discloses a fire/smoke detector for an air conditioner that, in response to a fire/smoke condition, opens a damper and forces air into the interior of a room to pressurize the room. U.S. Pat. No. 3,826,180 discloses a ventilating fan operable upon activation of a smoke detector. U.S. Pat. No. 4,177,461 discloses a smoke detector for a grain dryer including a transmitter for transmitting an alarm signal to a receiver.

In addition, U.S. Pat. No. 4,391,913 discloses a temperature sensor with a wireless transmitter that transmits signals to a receiver to control the regulation of a radiator system. U.S. Pat. Nos. 4,160,246 and 4,531,114 disclose smoke detectors with wireless transmitters. U.S. Pat. Nos. 4,276,064 and 4,675,203 disclose fire control systems for a paint spray booth and a powder spray booth, respectively. U.S. Pat. No. 4,818,970 discloses a fire control system for controlling air moving and filtering units used in conjunction with removal of hazardous particulate matter, such as asbestos.

Above mentioned prior art fails to disclose any system or method for controlling air moving units used in conjunction with a residence or dwelling in event of a toxic gas alarm condition such as that caused by a fire. Air moving blower motors can continue to run during alarm condition until their power source is terminated. As is well known, smoke spread from a fire will kill or render unconscious a person before actual fire consumes them. Until now, prior art has not addressed this residential condition.

### OBJECTS AND ADVANTAGES

Accordingly, several objects and advantages of this invention are:

(a) To provide method for possibly saving many lives that are now lost due to smoke or toxic gas inhalation.

(b) To provide means to automatically shut off a residential blower motor when an alarm condition exists.

(c) To provide Safety-off-switch that is inexpensive and easily manufactured.

(d) To provide safety-off-switch that could be installed within a residential air moving unit by the manufacturer of residential air moving units during original production of the air moving unit.

(e) To provide safety-off-switch that can control a 110 volt or a 220 volt blower motor.

(f) To provide safety-off-switch that requires no reset after each use.

(g) To provide safety-off-switch that can be used with any toxic gas detector, provided the detector is equipped with an electrical transmission line or cable known as an I/O data line.

(h) To provide safety-off-switch that can be installed within a standard 2″×4″ electrical rough-in box.

Still further objects and advantages of safety-off-switch will become apparent from a consideration of the ensuing drawings and description.

### DESCRIPTION OF THE DRAWINGS

FIG. 1-A is a detailed electrical circuit diagram of safety off switch

### SUMMARY OF THIS INVENTION

This invention is a safety-off-switch connected via electrical wire between residential smoke detectors and a residential air moving blower motor. safety-off-switch will serve to disconnect electrical power to blower motor in event of an alarm condition.

It is an object of safety off switch to be installed by a user who is not a skilled electrician or a skilled heating, air conditioning contractor.

More specifically, safety-off-switch is to be connected at end of “daisy-chained” smoke detectors. That is, end opposite to electrical power supplied by conventional main power lines, as safety-off-switch is not configured to pass on I/O data line signal to other smoke detectors.

It is still another object to provide safety-off-switch small enough to be installed within a standard electrical 2″×4″ rough-in box. Such a rough-in box is well known to the residential electrical trade.

According to yet another feature of safety off switch, a manufacturer of residential air moving units could easily install safety-off-switch into air moving unit during production of air moving unit.

As another object of this invention, safety-off-switch is designed to be produced using readily available and inexpensive parts.

### DETAILED DESCRIPTION OF THE PREFERRED EMBODIMENT

Residential construction is normally done in two stages of interior finish. First stage is known as “rough-in”. During this stage, construction trades install the first phase of their particular product. Electrical portion is to install rough-in boxes and appropriate wiring.

Second stage is known as the “finish”. It is during this stage that all electrical outlets, switches, lights, and smoke detectors are installed by connecting each device to wiring previously installed during the rough-in stage and attaching these devices to previously installed electrical rough-in boxes.

It is during “finish stage” of construction that safety-off-switch would be installed. Most residential building codes require all newly constructed residential dwelling units include installation of several strategically placed smoke detectors. Residential codes additionally require smoke detectors be permanently connected to conventional main electrical power lines, contain a battery backup and be interconnected via an electrical transmission line or cable known as an 10 data line, this is commonly referred to as being “daisy chained”, so that when one alarm sounds, all connected alarms will sound.

Safety-off-switch would connect to last smoke detector in chain, that is, end opposite electrical power supplied by conventional main power lines. safety-off-switch is not configured to pass on 110 data line signal. Safety-Off-Switch is attached to a conventional blank rough-in box cover plate “(not shown)”, such a cover plate would allow “LED” to fit into a drilled hole “(not shown)”.

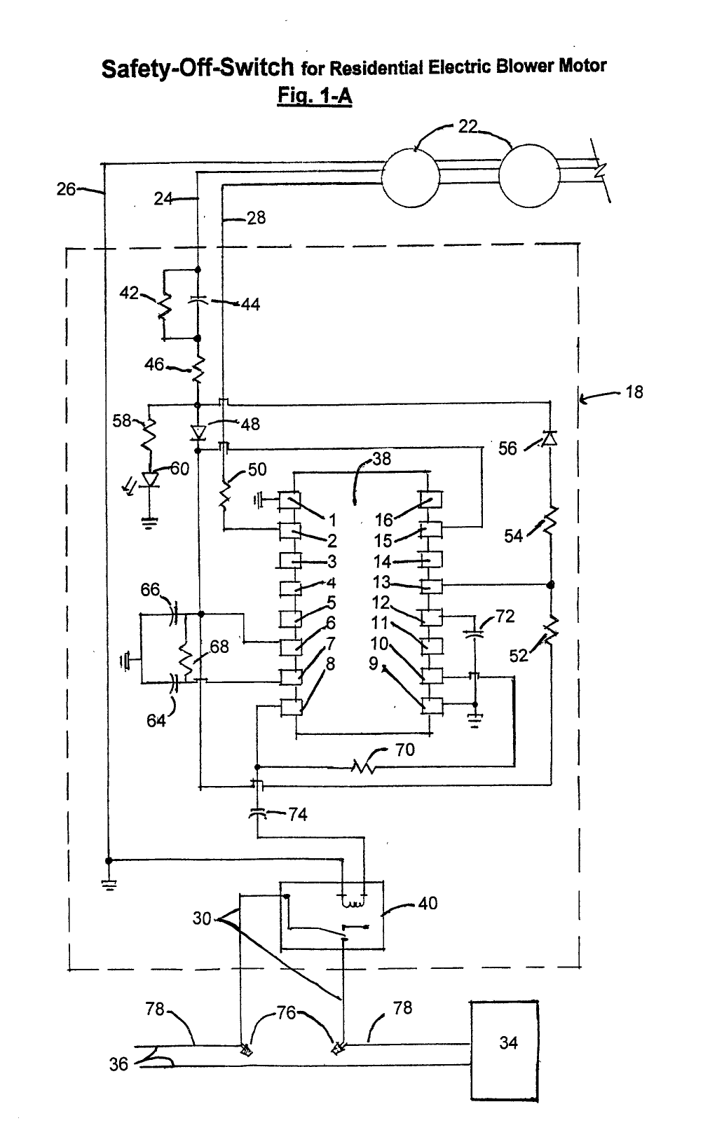

Referring now to drawings and in particular to FIG. 1-A in accordance to preferred embodiment of present invention. safety-off-switch 18 has been designed to be installed within an electrical 2″×4″ rough-in box (not shown), such a box is well known to residential electrical trade. This same box is normally used at rough-in stage of construction for required smoke detectors 22. During rough-in stage, an electrician would continue electrical power lines 24 & 26 and I/O data line 28 into such a rough-in box which would be used to connect safety-off-switch 18. Shown in FIG. 1-A. two electrical wires 30 would then be run from same rough-in box to residential air moving blower motor 34 location. Heating/cooling contractor would then connect wires 30 to common electrical leg 76 of blower motor 34, as shown in FIG. 1-A by cutting blower motor common wire 78 and splicing 76 each cut end to wires 30 run from safety-off-switch 18.

FIG. 1-A shows the circuit diagram of safety-off-switch 18. Three wires would be connected from daisy chained smoke detectors 22 to safety-off-switch 18. 120 v 60 Hz electrical power line 24, 120 v 60 Hz electrical common line 26, I/O data line 28. 120 vac is reduced to 10.3 vac by resister 42, capacitor 44, resister 46.

Half wave rectifier 48 converts 10.3 vac to 9.6 vdc.

I/O data line 28 is connected to pin 2 of IC chip 38. When I/O line 28 receives an alarm signal from daisy chained smoke detectors 22, horn circuit is enabled. This will activate relay 40. Relay 40, normally closed, will open and blower motor 34 will become disabled.

One element that has contributed to effective operation and reduced costs is the availability of a family of smoke-detector integrated circuits, Allegro A5348Ca 38 as produced by Allegro MicroSystems,Inc., http://www.allegromicro.com for one. IC combines the functions of a high-impedance comparator and a power flip-flop for driving an alarm horn.

Another cost saving element is use of a standard relay 40 such as R73 Series SPDT, 1 Form C as produced by NTE Electronics Inc., http://www.nteinc.com

### CONCLUSIONS RAMIFICATIONS AND SCOPE OF INVENTION

Accordingly, the reader will see that safety-off-switch is a very reliable, compact, yet economical device.

While the above description contains many specifics, this should not be construed as limitations on scope of invention, but rather as an exemplification of one preferred embodiment thereof. Many other variations are possible. For example, safety-off-switch can be connected to a carbon monoxide detector that has been equipped with an electrical transmission 110 data line or any other toxic gas detector equipped with an electrical transmission I/O data line.

Accordingly, scope of safety off switch should be determined not by embodiment illustrated, but by appended claims and their legal equivalents.

We claim:

1. A system for limiting spread of toxic gas within a residence, said system comprising interconnection of:
a. A residential air moving blower motor associated with heating or cooling of a residence.
b. A residential toxic gas sensing means for sensing characteristics of toxic gas such as fire generated smoke.
c. Transmission means for transmitting a toxic gas condition alarm signal upon activation of toxic gas sensing.
d. Means for receiving toxic gas condition alarm signal.
e. Control means for shutting down blower motor of residential air moving unit upon receipt of toxic gas condition alarm signal, terminating further movement of high volumes of air through a residence.

2. System of claim 1 further comprising heat sensing means for sensing a heat characteristic such as temperature and for providing heat alarm signal when heat characteristic is sensed, control means responsive to said heat alarm signal for shutting down blower motor of residential air moving unit.

3. System of claim 1 further comprising carbon monoxide sensing means for sensing a toxic gas characteristic such as carbon monoxide and providing control means responsive to toxic gas alarm signal, shutting down blower motor of residential air
